(19) United States
(12) Patent Application Publication
(10) Pub. No.: US 2008/0254816 A1
(43) Pub. Date: Oct. 16, 2008

(54) Method for Supporting Combinatorial Cs Call and Ims Session

(76) Inventors: Chunying Sun, Beijing (CN); Xiaoqiang Li, Beijing (CN)

Correspondence Address: THE FARRELL LAW FIRM, P.C., 333 EARLE OVINGTON BOULEVARD, SUITE 701, UNIONDALE, NY, 11553, US

(21) Appl. No.: 11/913,157

(22) PCT Filed: May 2, 2006
(86) PCT No.: PCT/KR06/01651

§ 371 Date: Oct. 30, 2007

(30) Foreign Application Priority Data
May 2, 2005 (CN) 200510069801.4

(51) Int. Cl. H04Q 7/20

(52) U.S. Cl. 455/466

(57) ABSTRACT

The method for supporting combinatorial CS call and IMS session that includes initiating an IMS domain session or sending a IMS relevant signaling to a called subscriber by a UE A, indicating a unique identification of the called terminal and checking whether his/her own identification matches with the unique one included in the message or not by the called. If a match is detected, sending back a normal response message. Otherwise, an abnormal one or none at all is sent back. Then, the several responses are combined and forwarded by a S-CSCF of the called according to available regulations. Thus, errors caused at the moment of terminal ability exchanging or session being established can be effectively avoided and the IMS unregistered UE can also share the IMS service.

### BACKGROUND OF THE INVENTION

1. Field of the Invention

The present invention relates to the field of 3G mobile communication, especially to a registration request which is not initiated by a subscriber in an Internet multimedia sub-system.

2. Description of the Related Art

The Internet Multimedia Sub-system (hereinafter referred to as IMS), as shown in FIG. 1, is a structural framework established by 3GPP to provide subscribers with the IMS service. Before applying the IMS service, a subscriber, i.e. user equipment (UE) 110 must register with a Service Call Session Control Function (hereinafter referred to as S-CSCF) of the IMS, informing a S-CSCF subscriber of a binding relationship between a subscriber's Public User Identification (hereinafter referred to as PUI) and an IP address of the subscriber 110 where is located in. During the process of registration, the subscribers can also inform the network of their characteristics and the support ability and so on. For details, please refer to the criterion TS 23.228 of 3GPP. In FIG. 1, a Proxy Call Session Control Function (hereinafter referred to as P-CSCF) 120 serves as a proxy gateway for IMS accessing, which usually is a certain gateway of the network in which the subscriber 110 currently locates. The address of the gateway is detected by the P-CSCF 120 and informed by the network when the subscriber 110 is performing IP access. For more information to implement the operation, please refer to criterion TS23.228. By parsing a home network name included in the PUI of the subscriber 110, the P-CSCF 120 finds out an Inquiry Call Session Control Function (I-CSCF) 130, through which the P-CSCF 120 can interact with a Home network registration Subscriber Server (hereinafter referred to as HSS) 150 to find out the S-CSCF 140 that the subscriber belongs to. After the I-CSCF 130 finds out the subscriber's S-CSCF, it forwards messages received from the P-CSCF 120 to the S-CSCF 140 to process them. If the S-CSCF 140 hasn't saved the subscriber's service attribute yet, it requests this information from the HSS 150. The S-CSCF 140 goes on processing messages received from the subscriber 110.

In an IMS system, messages between the UE and the P-CSCF use a Session Initiation Protocol (hereinafter referred to as SIP). In addition, SIP messages in an IMS system comply with the messages defined in RFC 3261, such as “INVITE”, “REGISTER”, “OPTIONS” which are triggered messages request and response principles. In the IMS system, the routing of a message is specifically important and in the header of each SIP message, there is a field named Request Uniform Resource Identification (Request-URI). With this field, the S-CSCF of the calling subscriber can find out the S-CSCF of a called subscriber. In the IMS system, the Request-URI field is usually identified by the subscriber's PUI. This PUI can be either the SIP URI indicated in the form of email or the TEL URI indicated in the form of telephone number. If the TEL URI is in service, it will be translated into the standard SIP URI with the method of ENUM DNS (please refer to IETF of RFC 2916) after it is received by the S-CSCF of the calling. Then, the SIP URI will be applied to identify the subscriber when the S-CSCF of the calling sends any message to the S-CSCF of the called.

According to the description above, every subscriber will inform his/her S-CSCF of a mapping relationship between his/her PUI and the IP address when he/she performs registration. In the IMS system, one subscriber possibly has one UE or several. When these several UEs are registering with the network, one PUI can be bound with different UE's IP address.

When the S-CSCF of the called subscriber is going to sends the SIP message to some subscriber identified by the PUI, it is necessary for S-CSCF to determine which UE this message should be sent to since the SIP message is encapsulated in the IP packet. If several UEs are identified by one PUI, the S-CSCF may send the same SIP message to the several UEs. Certainly, a Request Uniform Resource Identification in the SIP message is just the registered IP address of each UE.

On the basis of the IMS, 3GPP is working on the establishment of a standard Combinatorial Circuit Switching domain Call and IMS Session (hereinafter referred to as CSI), referring to FIG. 7 for more information.

Two CS and IMS clients are set in a User Equipment (UE), one for a Circuit Switching domain (hereinafter referred to as CS domain) call, and the other for a session of the IMS domain. When the CS domain call and the IMS domain session are conducted simultaneously between the same two UEs, then in the application layer of the UE, the same combinatorial service is presented to the subscriber by at least one Application Server (AS) connected the IMS domain. In this case, some interactions, operations, etc. between the CS domain and the IMS domain should be done.

In FIG. 7, the UEs access a CS domain core of the CS domain and a IMS domain core of the IMS domain through access networks corresponding to the each UE. The CS domain core refers to the network entity related to the CS domain call. In general, it may include the Mobile terminal Switching Center (hereinafter referred to as MSC), Visit Location Register (hereinafter referred to VLR), etc. The IMS domain core refers to the network entity related to the IMS domain session. In general, it may include all entities in FIG. 1.

Before conducting CSI service between two UEs, they must be in advance informed of the subscriber's ability in CSI supporting. The subscriber's ability in CSI supporting is transferred by an OPTIONS message. FIG. 2 illustrates the process of transferring a terminal's CSI supporting ability between two subscribers through the OPTIONS message in steps 201, 202 and 203, which may include parameters such as UE A's MS-ISDN, SIP URI, the type of media bearer, whether the CSI is supported or not, and so on. For details on these parameters, please refer to criterion 3GPP TS 23.279. Then the UE B sends the 200 OK message to the UE A in steps 205, 206 and 207, which includes the UE B's MS-ISDN, SIP URI, the type of media bearer, whether the CSI is supported or not, and so on. In this way, the UE A knows about UE B's terminal ability, and vice versa. The terminal ability of the partner is saved in the terminal of the UE and is monitored and controlled by a certain timer. If timeout happens to the timer, it begins to exchange a new process of terminal ability. In addition the terminal ability of the partner saved in the flash memory will be overwritten by a new one in steps 204 and 208.

As illustrated in FIG. 3, when one PUI of a subscriber is bound with several UEs, it is necessary for this subscriber's S-CSCF to send the same message as received from the subscriber in steps 301 and 302, to these several UEs in step 303 and 304. The “OPTIONS” message may be sent to several UEs in the process of exchanging terminal ability in the CSI. In general, after the called receives the “OPTIONS” message, it will return the “200 OK” message to the calling. Once the S-CSCF of the called receives the first “200 OK” messages in steps 305 and 306, it forwards the same “200 OK” message to the S-CSCF of the calling and then the message is routed to the UE of the calling in steps 307 and 308.

In the CSI, this integrated service is usually established between two terminals and the subsequently added IMS session is conducted between the same two terminals (e.g., a UE A and a UE B1 shown in FIG. 3) as that of CS domain call. If the “200 OK” message (which is sent from B2) does not include the related terminal's ability, the service is not established between the two same terminals when the calling wants to initiate the CSI service and if the terminal which feeds back the “200 OK” message can not support the CSI, no CSI service can be operated between the related subscribers. This is not good to the experience of subscribers.

### SUMMARY OF THE INVENTION

Therefore, an object of the present invention is to provide a method for supporting combinatorial CS domain call and IMS session.

To achieve the object mentioned above, a method for supporting combinatorial CS call and IMS session comprising steps of:

a) initiating an IMS domain session or sending a IMS relevant signaling to a called subscriber by a UE A, indicating a unique identification of the called terminal;

b) checking whether his/her own identification matches with the unique one included in the message or not by the called subscriber;

c) If yes, sending back a normal response message; otherwise, sending back an abnormal one or none at all; and

d) combining and forwarding these several responses by a S-CSCF of the called subscriber according to available regulations.

With method according to the present invention, errors caused at the moment of terminal ability exchanging or session being established can be effectively avoided and the IMS unregistered UE can also share the IMS service.

### BRIEF DESCRIPTION OF THE DRAWINGS

FIG. 1 shows a block diagram of architecture of an IMS's system;

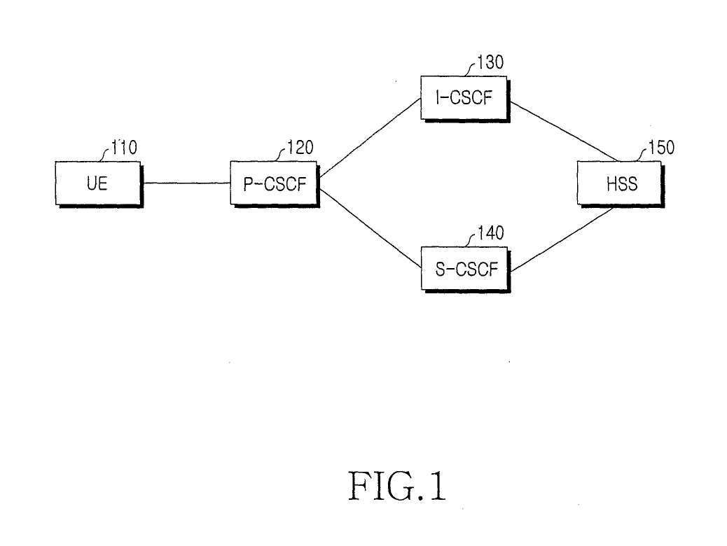

FIG. 2 illustrates a process that a UE exchanges terminal ability in virtue of an OPTIONS message;

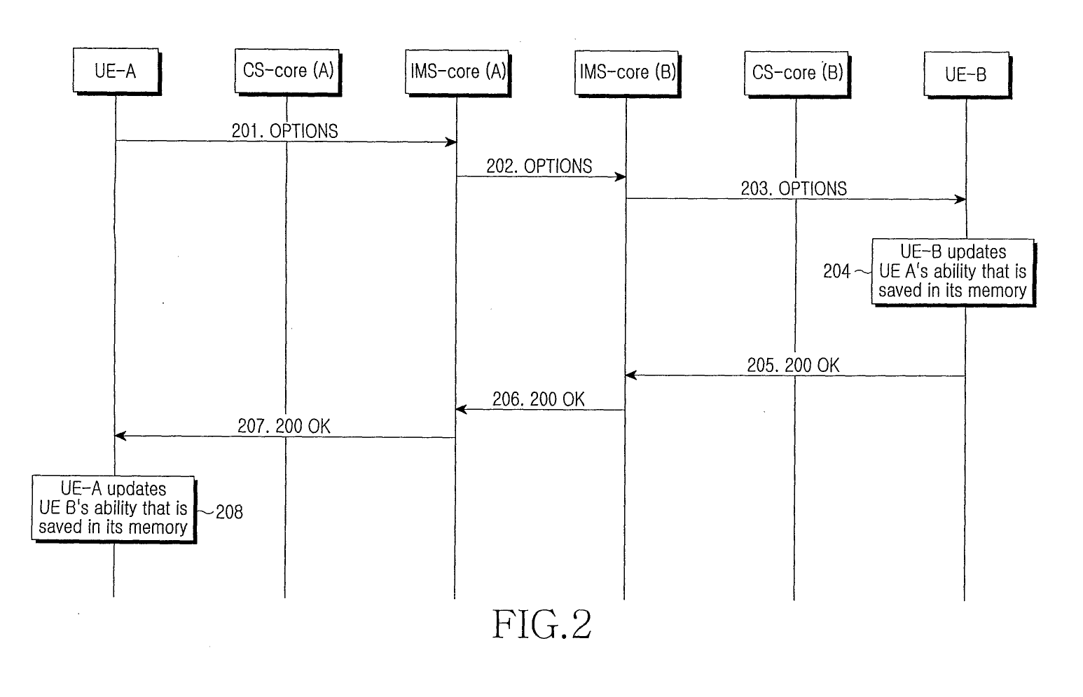

FIG. 3 shows that an IMS session is added between two UEs based on the CS domain call;

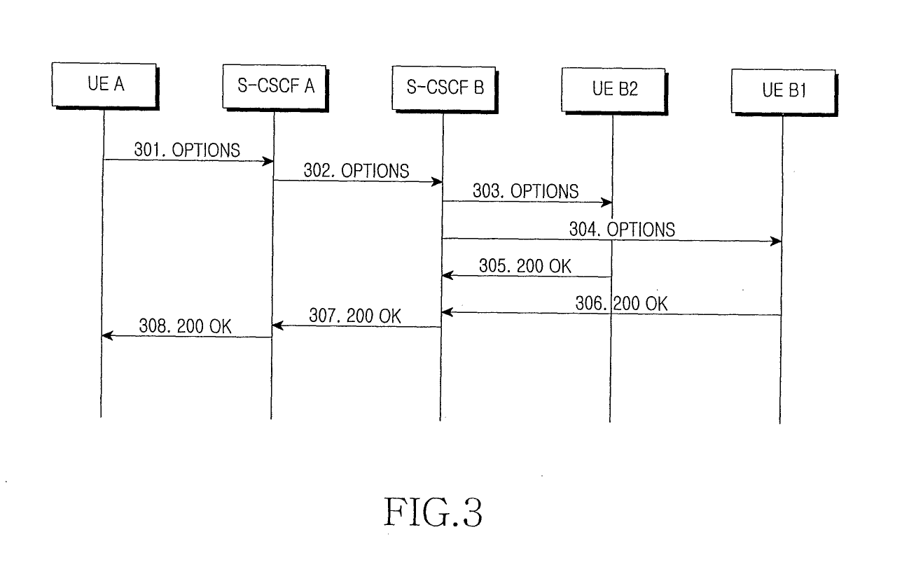

FIG. 4 shows a structure according to the present invention;

FIG. 5 illustrates an embodiment of exchanging terminal ability;

FIG. 6 illustrates an embodiment of initiating a session;

FIG. 7 shows an architecture of CSI.

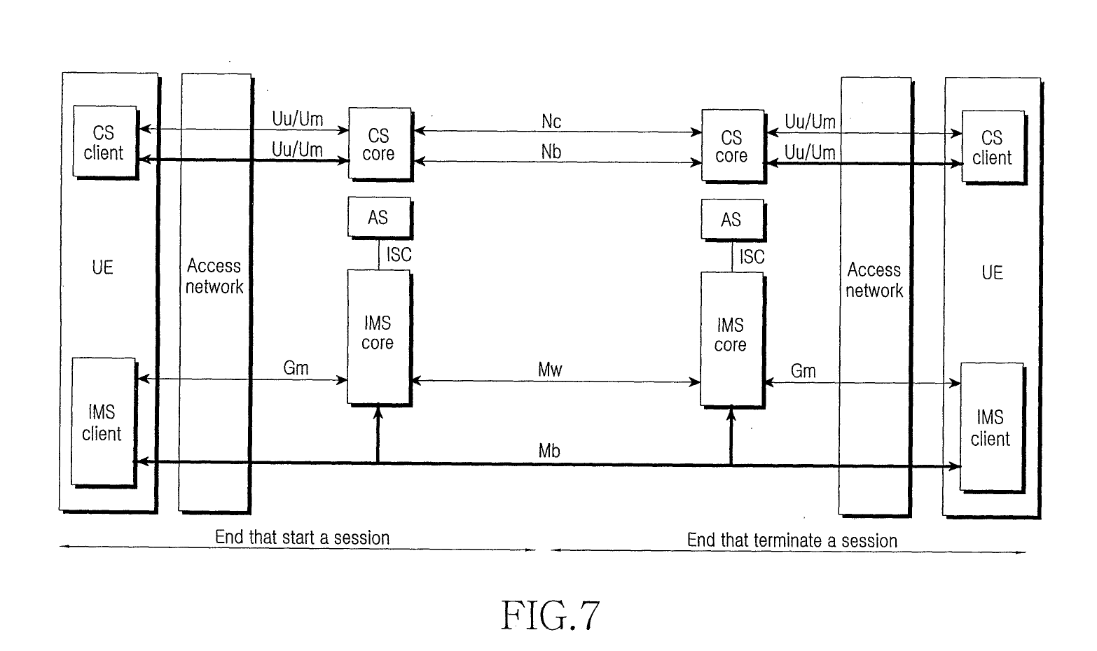

### DETAILED DESCRIPTION OF THE PREFERRED EMBODIMENTS

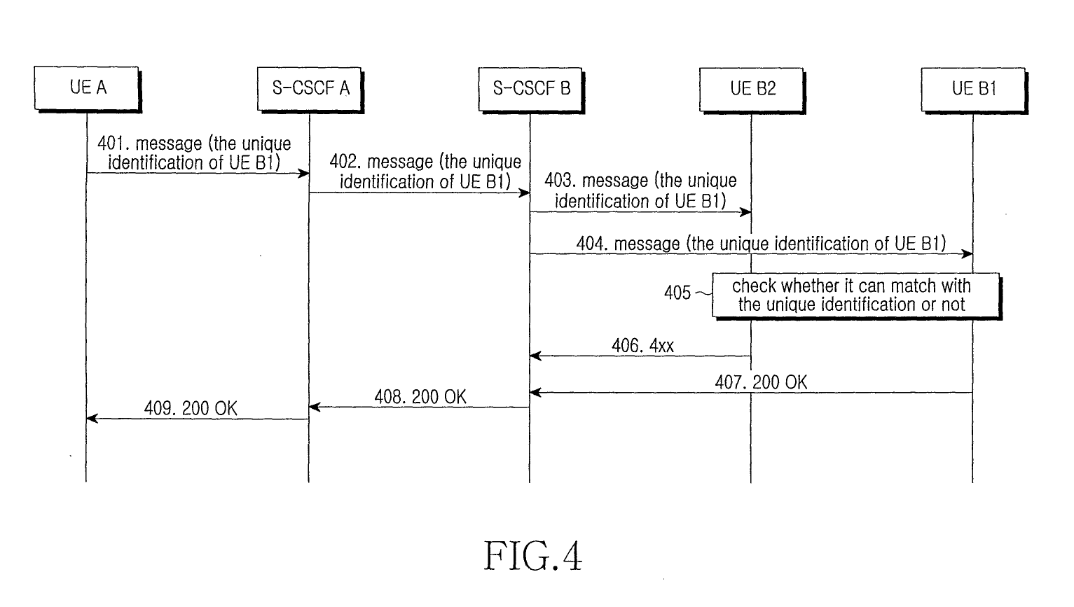

As illustrated in FIG. 4, a CS domain call has been established between a UE A and a terminal B1 (UE B1) of subscriber B.

In step 401, If the UE A initiates a request of terminal ability exchanging or an IMS session operating with the terminal of subscriber B, it sends a SIP message to a S-CSCF A, including parameters such as a Request-URI composed of the phone number of subscriber B's terminal B1, the terminal ability of UE A, and terminal B1's unique identifications like MS-ISDN, Personal ME identifier or SIP Request etc. The S-CSCF A translates the Request-URI into the SIP URI which is in the form of an email. In step 402, the S-CSCF A sends the SIP message to the S-CSCF B, including parameters such as the translated SIP URI, the terminal ability of UE A, and terminal B1's unique identifications like MS-ISDN, identifier or SIP Request etc. The S-CSCF B inquiries the UEs' registration information to know that this SIP URI corresponds to two IP addresses which belong to terminal B1 and terminal B2 (UE B2) respectively. Then, in steps 403 and 404, the S-CSCF B sends the SIP message to the B1 and B2 respectively, including the IP address of UE B1 or UE B2, the terminal ability of UE A, and terminal B1 's unique identifications such as MS-ISDN, identifier or SIP Request etc. After both UE B1 and UE B2 receive and process this SIP message, they find out that the identification of UE B1 is included in this message. In step 405, both UE B1 and UE B2 try to match with this identification, not UE B2 but UE B1 can go well and in consequence, only UE B1 will send the “200 OK” response message to the S-CSCF B in step 407, while UE B2 sends the S-CSCF B an abnormal response message such as the response message code 400-499 in step 406. After the S-CSCF B receives the “200 OK” message from UE B1, the S-CSCF B forwards it to the UE A in steps 408 and 409.

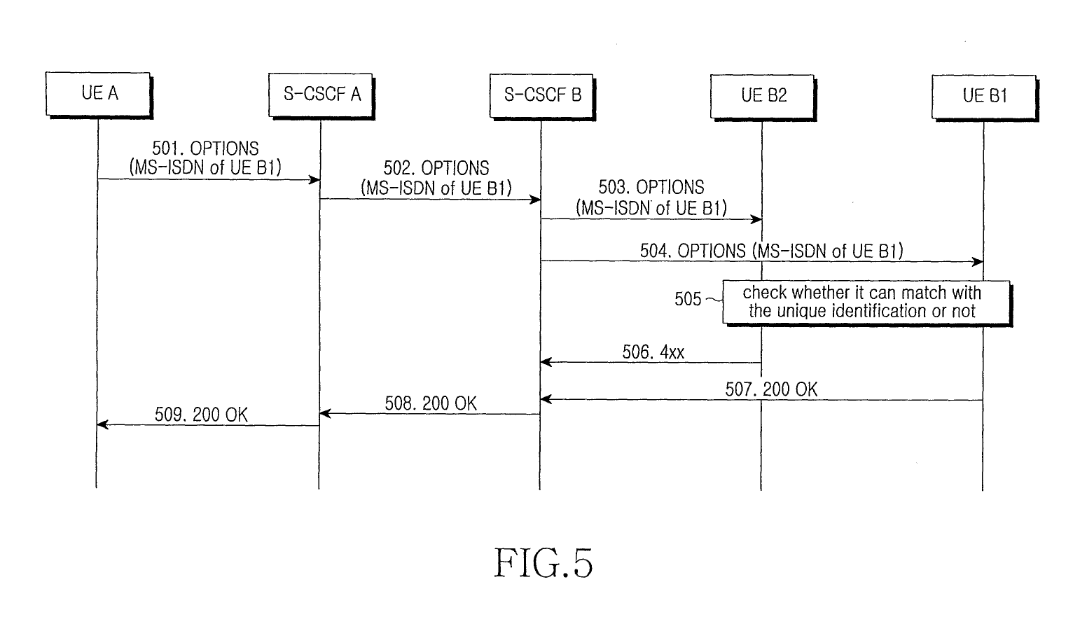

FIG. 5 describes an embodiment of the present invention.

A CS domain call has been established between the UE A and the terminal B1 (UE B1) of subscriber B.

In step 501, If the UE A wants to exchange the terminal ability with the UE B1, it sends the OPTIONS message to its S-CSCF A, including parameters such as a Request-URI composed of phone number of subscriber B's terminal B1, the terminal ability of UE A, and terminal B1 's unique identifications like MS-ISDN, identifier or SIP Request etc. The S-CSCF A translates the Request-URI into the SIP URI which is in the form of an email. In step 502, the S-CSCF A sends the “OPTIONS” message to the S-CSCF B, including parameters such as the translated SIP URI, the terminal ability of UE A, and UE B1's unique identifications like MS-ISDN, identifier or SIP Request etc. The S-CSCF B inquiries the UEs' registration information to know that this SIP URI corresponds to two IP addresses which belong to the terminal B1 and terminal B2 (UE B2) respectively. Then, in steps 503 and 504, the S-CSCF B sends the “OPTIONS” message to UE B1 and UE B2 respectively, including the IP address of UE B1 or UE B2, the terminal ability of UE A, and UE B1 's unique identifications like MS-ISDN, identifier or SIP Request etc. After both UE B1 and UE B2 receive and process this SIP message, they find out that the identification of UE B1 is included in this message. In step 505, both UE B1 and UE B2 try to match with this identification, not UE B2 but UE B1 can go well and in consequence, only UE B1 will send the “200 OK” response message to the S-CSCF B in step 507, while UE B2 sends the S-CSCF B an abnormal response message such as the response message code 400-499 in step 506. After the S-CSCF B receives the “200 OK” message from UE B1, it forwards the message to the UE A in steps 508 and 509.

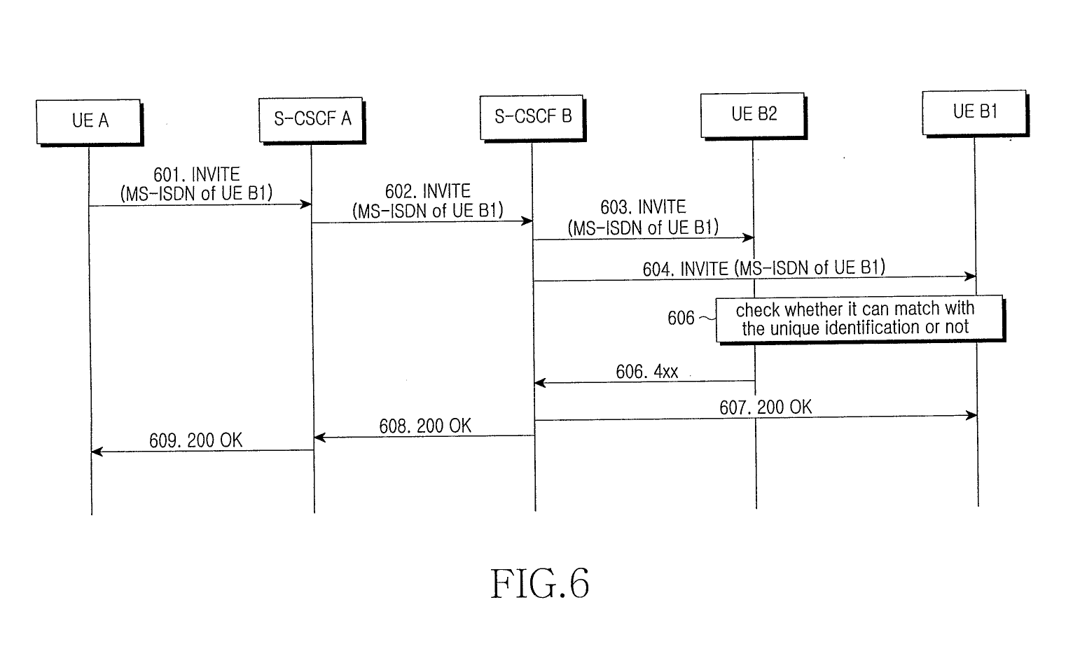

FIG. 6 describes another embodiment of the present invention.

A CS domain call has been established between the UE A and the terminal B1 (UE B1) of subscriber B.

In step 601, If the UE A wants to initiate a session request to the terminal of subscriber B, it sends the “INVITE” message to its S-CSCF A, including parameters such as a Request-URI composed of phone number of subscriber B's terminal B1, the terminal ability of UE A, and UE B1's unique identifications. The S-CSCF A translates the Request-URI into the SIP URI which is in the form of an email. In step 602, the S-CSCF A sends the “INVITE” message to the S-CSCF B, including parameters such as the translated SIP URI, the terminal ability of UE A, and UE B1's unique identifications like MS-ISDN, identifier or SIP Request etc. The S-CSCF B inquiries the UEs' registration information to know that this SIP URI corresponds to two IP addresses which belong to the terminal B1 and terminal B2 respectively. Then, in steps 603 and 604, the S-CSCF B sends the “INVITE” message to UE B1 and UE B2 respectively, including the IP address of UE B1 or UE B2, the terminal ability of UE A, and UE B1's unique identifications like MS-ISDN, identifier or SIP Request etc. After both UE B1 and UE B2 receive and process this SIP message, they find out that the identification of UE B1 is included in this message. In step 605, both UE B1 and UE B2 try to match with this identification, not UE B2 but UE B1 can go well and in consequence, only UE B1 will send the “200 OK” response message to the S-CSCF B in step 607, while UE B2 will send the S-CSCF B an abnormal response message such as the response message code 400-499 or send no message at all in step 606. After the S-CSCF B receives the “200 OK” message from UE B1, it forwards the message to the UE A in steps 608 and 609. Once B2 finds out that it can not match with this unique identification, it releases the allocated radio resources and does not need to wait for the partner's response.

1. A method for supporting combinatorial Circuit Switched (CS) call and Internet Multimedia Sub-System (IMS) session the method comprising steps of:
a) initiating by a subscriber an IMS domain session or sending an IMS relevant signaling to a called subscriber by a User Equipment (UE) A, indicating a unique identification of the called subscriber;
b) checking whether the called subscriber's own identification matches with the unique identification included in the message;
c) if a match is detected, sending back a normal response message; otherwise, sending back one of an abnormal message or no message at all; and
d) combining and forwarding the several responses by a Service-Call Session Control Function (S-CSCF) of the called subscriber.

2. The method according to claim 1, wherein step a) further comprises that Subscriber A sends an “OPTIONS” message or an “INVITE” message to the called subscriber.

3. The method according to claim 2, wherein step a) further comprises that the “INVITE” message includes a MS-ISDN identifier or Session Initiation Protocol (SIP) Request of the called subscriber.

4. The method according to claim 1, wherein after the called subscriber determines that there is no match with the unique identification, allocated radio resources are released.
